(19) United States
(12) Patent Application Publication
(10) Pub. No.: US 2023/0196746 A1
(43) Pub. Date: Jun. 22, 2023

(54) DATA GENERATION METHOD, DATA GENERATION APPARATUS AND PROGRAM

(71) Applicant: NIPPON TELEGRAPH AND TELEPHONE CORPORATION, Tokyo (JP)

(72) Inventors: Shinobu KUDO, Musashino-shi, Tokyo (JP); Ryuichi TANIDA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 17/769,403

(22) PCT Filed: Nov. 1, 2019
(86) PCT No.: PCT/JP2019/043055

§ 371 Date: Apr. 15, 2022

(51) Int. Cl. G06V 10/778; G06V 20/70; G06V 10/82; G06V 10/776

(52) U.S. Cl. CPC G06V 10/778; G06V 20/70; G06V 10/82; G06V 10/776

(57) ABSTRACT

One aspect of the present invention is a data generation method which generates data based on a predetermined estimation model, the data generation method includes a generation step of generating data estimated as a predetermined label by the estimation model and provided with the predetermined label, and generated data has at least either one of a feature close to data to which a label different from the predetermined label is imparted or a feature different from known data to which the predetermined label is imparted.

### TECHNICAL FIELD

The present invention relates to a data generation method, a data generation device and a program.

### BACKGROUND ART

In recent years, various technologies using machine learning have been proposed. However, the machine learning requires a lot of learning data. In addition, there is a problem that, when many pieces of learning data are the learning data to which a specific label is imparted, estimation accuracy declines in the case of estimating unknown data by a learned neural network. Then, for example, a technology of generating data simulating an event of a low occurrence frequency in a reality space has been proposed. (See Patent Literature 1) It is the technology of generating data based on an event of a not-low occurrence frequency and known information in the reality space or the like.

### CITATION LIST

### Patent Literature

Patent Literature 1: Japanese Patent Application No. 2018-509685

### SUMMARY OF THE INVENTION

### Technical Problem

However, in the proposed technology (Patent Literature 1), data allowing accurate learning of a model when taking held learning data into consideration cannot be always generated.

FIG. 15 is a diagram illustrating an example of a distribution of estimation results by a learned neural network which has learned using learning data generated by the proposed technology. FIG. 15 indicates that the estimation results by the learned neural network are classified into any of a label A, a label B or a label C.

FIGS. 16 are explanatory diagrams explaining a problem caused due to the distribution of the learning data. FIG. 16(a) illustrates an example of the distribution of the learning data. FIG. 16(a) illustrates an example of the distribution of the learning data for making the neural network learn. FIG. 16(a) illustrates the learning data classified into the label A, the learning data classified into the label B, and the learning data classified into the label C. FIG. 16(a) illustrates that boundaries of the learning data classified into the label A, the learning data classified into the label B and the learning data classified into the label C are distinct.

FIG. 16(b) illustrates true label data of test data inputted to the neural network which has learned by the learning data illustrated in FIG. 16(a). FIG. 16(b) illustrates the test data which should be classified into the label A, the test data which should be classified into the label B, and the test data which should be classified into the label C by the neural network. The test data which should be classified into the label A by the neural network is the data positioned at the boundary of a set of the data classified into the label A. The test data which should be classified into the label B by the neural network is the data positioned at the boundary of the set of the data classified into the label B. The test data which should be classified into the label C by the neural network is the data positioned at the boundary of the set of the data classified into the label C.

FIG. 16(c) illustrates an example of the estimation results for which the learned neural network which has learned using the learning data illustrated in FIG. 16(a) estimates classification destinations of the test data illustrated in FIG. 16(b). FIG. 16(c) illustrates that the test data which should be classified into the label A is classified as the data of the label B. FIG. 16(c) illustrates that the test data which should be classified into the label B is classified as the data of the label C. FIG. 16(c) illustrates that the test data which should be classified into the label C is classified as the data of the label A.

As illustrated in FIG. 16, the estimation results of the data by the learned neural network are sometimes erroneous since there is no data near the label boundary in the learning data.

Further, in the case where the distribution of the learning data is inappropriate, likelihood is sometimes inappropriate even though the classification destination of the test data itself is appropriate. The likelihood is an index indicating a probability that a classification result of the test data by the learned neural network is correct. Therefore, even when the classification result itself is correct, in the case of mapping the classification result in a virtual predetermined space according to the likelihood, an area of a low data density is sometimes generated. In such a case, the likelihood tends to be low even though the classification destination itself is appropriate, and it is conceivable that it has an effect in the case of performing threshold determination of the likelihood or the like.

In such a manner, in a conventional learning method, an inappropriate result is sometimes estimated since the neural network cannot be made to learn by appropriate learning data.

In consideration of circumstances described above, an object of the present invention is to provide a technology of generating learning data which suppress decline of estimation accuracy by a learned neural network.

### Means for Solving the Problem

One aspect of the present invention is a data generation method which generates data based on a predetermined estimation model, the data generation method includes a generation step of generating data estimated as a predetermined label by the estimation model and provided with the predetermined label, and generated data has at least either one of a feature close to data to which a label different from the predetermined label is imparted or a feature different from known data to which the predetermined label is imparted.

Effects of the Invention

The present invention makes it possible to provide a technology of generating learning data which suppresses decline of estimation accuracy by a learned neural network.

### BRIEF DESCRIPTION OF DRAWINGS

FIG. 1 is an explanatory diagram explaining an outline of a learning data generation device of an embodiment.

FIG. 2 is a diagram illustrating an example of a hardware configuration of the learning data generation device of the embodiment.

FIG. 3 is a diagram illustrating an example of a functional configuration of a control unit in the embodiment.

FIG. 4 is a flowchart illustrating an example of a flow of processing executed by the learning data generation device in a discriminative NN learning mode of the embodiment.

FIG. 5 is a flowchart illustrating an example of the flow of the processing executed by the learning data generation device in a learning target DNN learning mode of the embodiment.

FIG. 6 is a flowchart illustrating an example of the flow of the processing executed by the learning data generation device in a first generative NN learning mode of the embodiment.

FIG. 7 is a flowchart illustrating an example of the flow of the processing executed by the learning data generation device in a second generative NN learning mode of the embodiment.

FIG. 8 is a flowchart illustrating an example of the flow of the processing that a learning data generation device 1 of the embodiment generates learning data.

FIG. 9 is an explanatory diagram explaining the outline of a learning data generation device of a modification.

FIG. 10 is a diagram illustrating an example of the hardware configuration of the learning data generation device of the modification.

FIG. 11 is a diagram illustrating an example of the functional configuration of a control unit of the modification.

FIG. 12 is a flowchart illustrating an example of the flow of the processing executed by the learning data generation device in the learning target DNN learning mode of the modification.

FIG. 13 is a flowchart illustrating an example of the flow of the processing executed by the learning data generation device in a third generative NN learning mode of the modification.

FIG. 14 is a flowchart illustrating an example of the flow of the processing that the learning data generation device of the embodiment generates a generative NN learned model.

FIG. 15 is a diagram illustrating a distribution of estimation results by a learned neural network which has learned by prior art.

FIGS. 16 are explanatory diagrams explaining a problem caused due to the distribution of the learning data.

### DESCRIPTION OF EMBODIMENTS

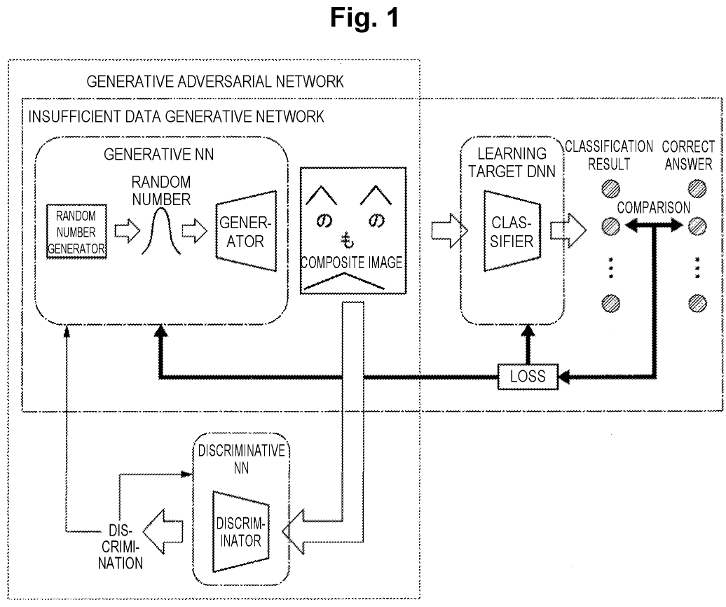

FIG. 1 is an explanatory diagram explaining an outline of a learning data generation device 1 of the embodiment. The learning data generation device 1 generates learning data for making a predetermined deep neural network (DNN) (hereinafter referred to as “learning target DNN”) learn. The learning target DNN may be any deep neural network, and may be, for example, a classifier or an autoencoder. Note that, hereinafter, the neural network includes the deep neural network.

Learning specifically means that a value of a parameter in a machine learning model expressed by the neural network is suitably adjusted for example. In description below, learning to be A means that the value of the parameter in the machine learning model expressed by the neural network is adjusted so as to satisfy A. A indicates a condition predetermined for each neural network.

The neural network in the description below may be a fully connected perceptron, or may be a convolutional neural network. In the learning of the neural network, the parameter of the neural network may be adjusted by algorithm of any machine learning, and may be adjusted by the algorithm of an error back propagation method, for example.

The learning data includes at least input data. The input data may be any data as long as it is the data which can be generated by a plurality of generation methods. The plurality of generation methods are, for example, an artificial generation method and a non-artificial generation method. The input data is, for example, an image. In a case where the input data is the image, the artificial generation method is a method of generating the image by processing or composition of the image for example, and the non-artificial generation method is a method of generating a picture by photographing for example.

The learning data may include or may not include correct answer data (correct answer label) corresponding to the input data depending on what kind of deep neural network the learning target DNN is. For example, in the case where the learning target DNN is a classifier, the learning data also includes the correct answer data. For example, in the case where the learning target DNN is an autoencoder, the learning data does not include the correct answer data.

The correct answer data indicates content indicated by the input data. In the case where the input data is an image, the correct answer data is the content indicated by the image, for example. The content indicated by the input data is, when the input data is the image of an animal for example, the animal indicated by the image.

Hereinafter, in order to simplify the description, the learning data generation device 1 will be described with the case where the learning target DNN is a classifier as an example. Hereinafter, in order to simplify the description, the learning data generation device 1 will be described with the case where the input data is an image as an example. In addition, in order to simplify the description hereinafter, the learning data generation device 1 will be described with the case where the learning data also includes the correct answer data as an example. Hereinafter, in order to simplify the description, the learning data generation device 1 will be described with the case where the plurality of generation methods of the input data are two generation methods of the artificial generation method and the non-artificial generation method as an example.

The learning data generation device 1 includes two deep neural networks that are an insufficient data generative network and a generative adversarial network (GAN). The insufficient data generative network includes the learning target DNN, and a deep neural network (hereinafter referred to as “generative NN”) which generates the input data to be inputted to the learning target DNN based on a random number value.

The generative NN includes a random number generator and a generator. The random number generator generates a random number. The generator generates the input data based on the random number generated by the random number generator. The generative NN generates not only the input data but also the correct answer data corresponding to the input data based on the random number value.

Based on a difference (hereinafter referred to as “classification error”) between a result (hereinafter referred to as “classification result”) of classification by the learning target DNN to the generated input data and the correct answer data corresponding to the input data, the generative NN learns so as to increase the classification error. More specifically, the generative NN learns so as to increase a loss function indicating a size of the classification error. The classification error is cross entropy, for example.

The GAN includes the generative NN and a discriminative neural network (hereinafter referred to as “discriminative NN”). The discriminative NN includes a discriminator. The discriminative NN is a deep neural network which discriminates whether or not the input data generated by the generative NN satisfies a predetermined condition (hereinafter referred to as “generation condition”) regarding the generation method of the input data by the discriminator. For example, in the case where the input data generated by the generative NN is an image, the generation condition is a condition that the image of the input data is a non-composite image, for example. The non-composite image is a prepared image. The non-composite image is an image which is not a processed or composed image (hereinafter referred to as “composite image”). The non-composite image is a picture, for example. Hereinafter, in order to simplify the description, the learning data generation device 1 will be described with the case that the generation condition is the condition that the image of the input data is the non-composite image as an example.

In the GAN, the generative NN learns based on a result (hereinafter referred to as “discrimination result”) of discrimination by the discriminative NN. Specifically, the generative NN in the GAN learns so as to increase a probability that the image generated by the generative NN is discriminated as the non-composite image by the discriminative NN. That is, in the GAN, the generative NN learns so as to increase the probability that the result of the discrimination by the discriminative NN is erroneous.

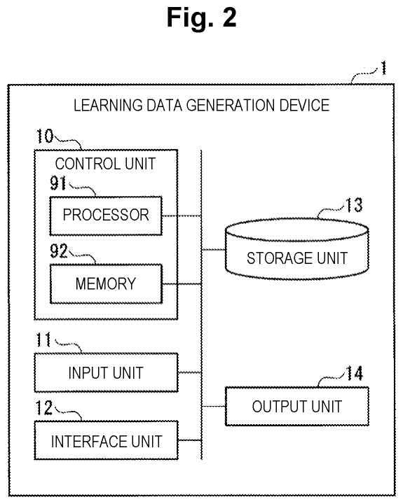

FIG. 2 is a diagram illustrating an example of a hardware configuration of the learning data generation device 1 of the embodiment.

The learning data generation device 1 includes a control unit 10 including a processor 91 such as a CPU (Central Processing Unit) and a memory 92 connected by a bus, and executes a program. The learning data generation device 1 functions as the device including the control unit 10, an input unit 11, a storage unit 13 and an output unit 14 by execution of the program. More specifically, the processor 91 reads the program stored in the storage unit 13, and stores the read program in the memory 92. By the processor 91 executing the program stored in the memory 92, the learning data generation device 1 functions as the device including the control unit 10, the input unit 11, an interface unit 12, the storage unit 13 and the output unit 14.

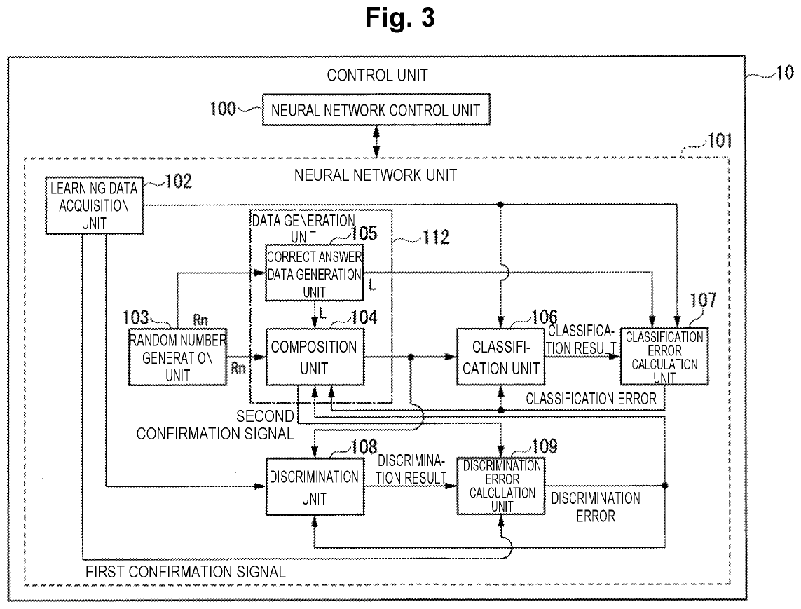

The control unit 10 controls operations of various kinds of functional units provided in the learning data generation device 1. Details of the control unit 10 will be described later using FIG. 3.

The input unit 11 is configured including an input device such as a mouse, a keyboard or a touch panel. The input unit 11 may be configured as an interface which connects the input devices to the present device. The input unit 11 receives input of various kinds of information to the present device. The input unit 11 receives the input of the learning data, for example. The learning data includes a set of the input data and the correct answer data. The content indicated by the correct answer data included in the learning data is the content of the corresponding input data.

The interface unit 12 is configured including a communication interface for connecting the present device to an external device. The interface unit 12 communicates with the external device via a wire or radio. The external device may be a storage device such as a USB (Universal Serial Bus) memory, for example. In the case where the external device outputs the learning data for example, the interface unit 12 acquires the learning data outputted by the external device by communication with the external device.

The storage unit 13 is configured using a non-transitory computer-readable storage medium device such as a magnetic hard disk device or a semiconductor storage device. The storage unit 13 stores various kinds of information regarding the learning data generation device 1. The storage unit 13 stores the learning data inputted via the input unit 11 or the interface unit 12. The storage unit 13 stores the discrimination result, for example. The storage unit 13 stores the discrimination result to be described later, for example. The storage unit 13 stores the classification result, for example. The storage unit 13 stores the classification error, for example. The storage unit 13 stores the learning data including the input data generated by a composition unit 104 to be described later, for example.

The output unit 14 outputs various kinds of information. The output unit 14 outputs a composite image generated by the generative NN, for example. The output unit 14 is configured including a display device such as a CRT (Cathode Ray Tube) display, a liquid crystal display or an organic EL (Electro-Luminescence) display, for example. The output unit 14 may be configured as an interface which connects the display devices to the present device.

FIG. 3 is a diagram illustrating an example of a functional configuration of the control unit 10 in the embodiment. The control unit 10 includes a neural network control unit 100 and a neural network unit 101.

In addition, the neural network control unit 100 controls the operation of the neural network unit 101. The neural network control unit 100 determines an operation mode of the learning data generation device 1. The operation mode of the learning data generation device 1 includes, specifically, a first generative NN learning mode, a second generative NN learning mode, a discriminative NN learning mode, a learning target DNN learning mode and an input data generation mode.

The first generative NN learning mode is the operation mode in which the generative NN learns based on the discrimination result. The second generative NN learning mode is the operation mode in which the generative NN learns based on the classification result. The discriminative NN learning mode is the operation mode in which the discriminative NN learns. The learning target DNN learning mode is the operation mode in which the learning target DNN learns. The input data generation mode is the operation mode in which the input data is generated by a generative NN learned model. The generative NN learned model is a learning model for which a predetermined end condition (hereinafter referred to as “generative NN end condition”) is satisfied, and is the learning model expressed by the generative NN.

The generative NN end condition includes a first included condition and a second included condition below, for example. The first included condition is the condition that the probability that the discriminative NN determines that the input data generated by the generative NN is a non-composite image is a predetermined probability or higher. The second included condition is the condition that the difference between the result of processing by the learning target DNN to the input data generated by the generative NN and the correct answer data is smaller than a predetermined difference.

The neural network unit 101 includes a learning data acquisition unit 102, a random number generation unit 103, a data generation unit 112, a classification unit 106, a classification error calculation unit 107, a discrimination unit 108 and a discrimination error calculation unit 109. Each functional unit provided in the neural network unit 101 is operated by the operation according to the operation mode determined by the neural network control unit 100. The random number generation unit 103 and the composition unit 104 are a part of the generative NN. The classification unit 106 is a part of the learning target DNN. The discrimination unit 108 is a part of the discriminative NN.

The learning data acquisition unit 102 acquires the learning data inputted via the input unit 11 or the interface unit 12. The learning data inputted via the input unit 11 or the interface unit 12 is prepared learning data and is the learning data including the input data not generated in the composition unit 104 to be described later.

The input data of the learning data acquired by the learning data acquisition unit 102 is outputted to the classification unit 106 and the discrimination unit 108. The correct answer data of the learning data acquired by the learning data acquisition unit 102 is outputted to the classification error calculation unit 107. In the case of outputting the acquired learning data to the discrimination unit 108, the learning data acquisition unit 102 outputs a signal (hereinafter referred to as “first confirmation signal”) indicating that the learning data is outputted from the learning data acquisition unit 102 to the discrimination unit 108 to the discrimination error calculation unit 109.

The random number generation unit 103 generates the random number value. The random number generation unit 103 outputs the generated random number value to the data generation unit 112.

The data generation unit 112 includes the composition unit 104 and a correct answer data generation unit 105.

The composition unit 104 is a neural network (generative neural network) which generates the input data according to an acquired random number value Rn. For example, the composition unit 104 inputs the acquired random number value to a predetermined function independent variables of which are the acquired random number value and a value indicating a position of each pixel of the image to be generated. Then, the composition unit 104 generates the image for which the value of output of the predetermined function is the value of each pixel as the input data, for example.

In the case of outputting the generated input data to the discrimination unit 108, the composition unit 104 outputs a signal (hereinafter referred to as “second confirmation signal”) indicating that the input data is outputted from the composition unit 104 to the discrimination unit 108 to the discrimination error calculation unit 109.

The correct answer data generation unit 105 generates correct answer data L for the input data generated by the composition unit 104. The correct answer data generation unit 105 generates the correct answer data L based on the random number value Rn which is the random number value generated by the random number generation unit 103 and is inputted to the composition unit 104, for example. The generated correct answer data L is inputted to the classification error calculation unit 107.

The classification unit 106 is a neural network which determines a classification destination according to the content indicated by the input data, for the inputted input data. For example, in the case of determining that the input data is the image indicating a cat, the classification unit 106 determines the classification destination of the input data to be a set of the images of a cat among a plurality of sets predetermined for the content of the image.

The classification error calculation unit 107 calculates the classification error which is a value indicating the difference between the classification result and the correct answer data L, based on the classification result by the classification unit 106 and the correct answer data L. The classification error is outputted to the composition unit 104 and the classification unit 106.

The discrimination unit 108 determines whether or not the inputted input data satisfies the generation condition. That is, the discrimination unit 108 determines which method of the predetermined generation methods the generation method of the input data is.

The discrimination error calculation unit 109 is a neural network which calculates a discrimination error based on the discrimination result. The discrimination error is a value indicating the probability that the method indicated by the discrimination result and the generation method of the input data inputted to the discrimination unit 108 are different. Since the discrimination error is the value indicating the probability that the method indicated by the discrimination result and the generation method of the input data inputted to the discrimination unit 108 are different, the discrimination results for a plurality of times by the discrimination unit 108 are required. Since the discrimination error is the value indicating the probability that the method indicated by the discrimination result and the generation method of the input data inputted to the discrimination unit 108 are different, it is the value indicating the probability that the discrimination result is correct. The discrimination error is, for example, binary cross entropy calculated in the GAN.

Specifically, the discrimination error calculation unit 109 determines that the input data inputted to the discrimination unit 108 is a non-composite image in the case of receiving the first confirmation signal. The discrimination error calculation unit 109 determines that the input data inputted to the discrimination unit 108 is a composite image in the case of receiving the second confirmation signal. The discrimination error calculation unit 109 calculates the discrimination error which is the value indicating the difference between a determination result and the discrimination result of the discrimination unit 108, based on the determination result. The discrimination error is outputted to the composition unit 104 and the discrimination unit 108.

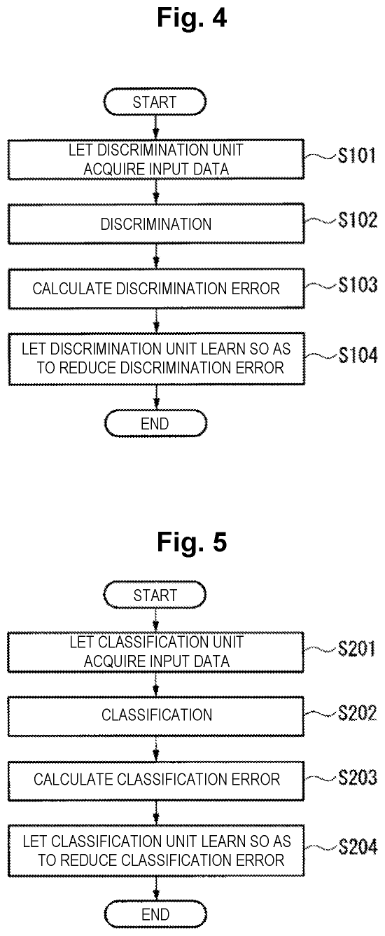

FIG. 4 is a flowchart illustrating an example of a flow of processing executed by the learning data generation device 1 in the discriminative NN learning mode of the embodiment.

The discrimination unit 108 acquires the input data (step S101). Then, the discrimination unit 108 acquires the discrimination result (step S102). To acquire the discrimination result is, specifically, to determine whether or not the input data satisfies the generation condition and acquire the determination result.

The discrimination error calculation unit 109 calculates the discrimination error based on the discrimination result in step 5102 (step S103). Specifically, the discrimination error calculation unit 109 determines which of the first confirmation signal and the second confirmation signal is received first. In the case of receiving the first confirmation signal, the discrimination error calculation unit 109 determines that the input data is a non-composite image. In the case of receiving the second confirmation signal, the discrimination error calculation unit 109 determines that the input data is a composite image. The discrimination error calculation unit 109 calculates the value indicating magnitude of the difference between the determination result of determining whether the input data is the composite image or the non-composite image and the discrimination result as the discrimination error.

After step 5103, the discrimination unit 108 learns so as to reduce the discrimination error, based on the discrimination error (step S104).

FIG. 5 is a flowchart illustrating an example of the flow of the processing executed by the learning data generation device 1 in the learning target DNN learning mode of the embodiment.

The classification unit 106 acquires the input data (step S201). Then, the classification unit 106 acquires the classification result (step S202). Next, the classification error calculation unit 107 calculates the classification error, based on the classification result in step S202 and the correct answer data (step S203). Then, the classification unit 106 learns so as to reduce the classification error, based on the classification error (step S204).

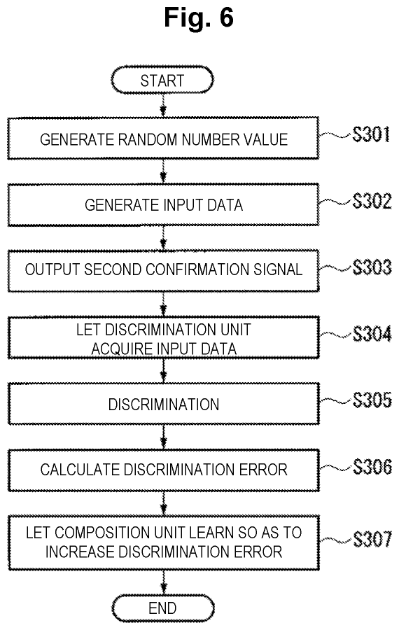

FIG. 6 is a flowchart illustrating an example of the flow of the processing executed by the learning data generation device 1 in the first generative NN learning mode of the embodiment.

The random number generation unit 103 generates the random number value (step S301). Then, the composition unit 104 generates the input data according to the generated random number value (step S302). Next, the composition unit 104 outputs the second confirmation signal (step S303). Then, the discrimination unit 108 acquires the input data (step S304).

Next, the discrimination unit 108 discriminates the input data (step S305). Then, the discrimination error calculation unit 109 calculates the discrimination error, based on the discrimination result in step 5305 (step S306). Specifically, the discrimination error calculation unit 109 determines that the input data is the composite image since the second confirmation signal is outputted in step 5303 first. Then, the discrimination error calculation unit 109 calculates the value indicating the magnitude of the difference between the determination result of determining whether the input data is the composite image or the non-composite image and the discrimination result as the discrimination error.

After step 5306, the composition unit 104 learns so as to increase the discrimination error, based on the discrimination error (step S307).

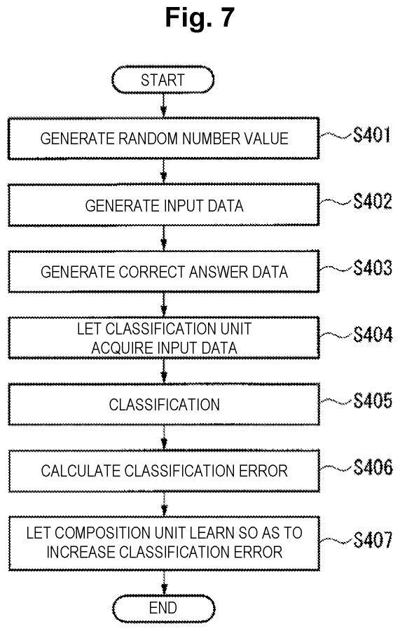

FIG. 7 is a flowchart illustrating an example of the flow of the processing executed by the learning data generation device 1 in the second generative NN learning mode of the embodiment.

The random number generation unit 103 generates the random number value (step S401). Then, the composition unit 104 generates the input data according to the generated random number value (step S402). Next, the composition unit 104 outputs the second confirmation signal (step S403). Then, the classification unit 106 acquires the input data (step S404).

Next, the classification unit 106 classifies the input data (step S405). Then, the classification error calculation unit 107 calculates the classification error, based on the classification result in step 5405 and the correct answer data (step S406). Then, the composition unit 104 learns so as to increase the classification error, based on the classification error (step S407).

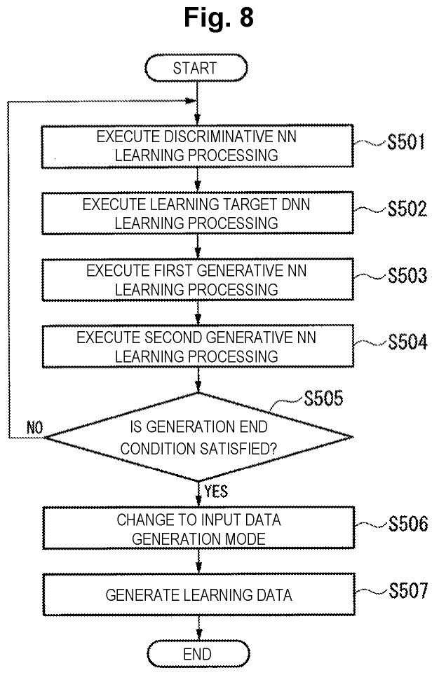

FIG. 8 is a flowchart illustrating an example of the flow of the processing that the learning data generation device 1 of the embodiment generates the learning data. More specifically, FIG. 8 is the flowchart illustrating an example of the flow of the processing that the learning data generation device 1 generates the generative NN learned model and then generates the learning data by the generative NN learned model. The processing in step S501-step 5506 below is executed by the neural network control unit 100, for example.

The processing (hereinafter referred to as “discriminative NN learning processing”) in the discriminative NN learning mode is repeatedly executed until a predetermined end condition (hereinafter referred to as “discriminative NN end condition”) is satisfied (step S501). The discriminative NN learning processing is specifically the processing illustrated in FIG. 4. The discriminative NN end condition is, for example, the condition that the discriminative NN learning processing is executed to a predetermined number of pieces of the input data.

Then, the processing (hereinafter referred to as “learning target DNN learning processing”) in the learning target DNN learning mode is repeatedly executed until a predetermined end condition (hereinafter referred to as “learning target DNN end condition”) is satisfied (step S502). The learning target DNN learning processing is specifically the processing illustrated in FIG. 5. The learning target DNN end condition is, for example, the condition that the learning target DNN learning processing is executed to the predetermined number of pieces of the input data.

Next, the processing (hereinafter referred to as “first generative NN learning processing”) in the first generative NN learning mode is repeatedly executed until a predetermined end condition (hereinafter referred to as “first generative NN learning end condition”) is satisfied (step S503). The first generative NN learning processing is specifically the processing illustrated in FIG. 6. The first generative NN learning end condition is, for example, the condition that the first generative NN learning processing is executed to the predetermined number of pieces of the input data.

Then, the processing (hereinafter referred to as “second generative NN learning processing”) in the second generative NN learning mode is repeatedly executed until a predetermined end condition (hereinafter referred to as “second generative NN learning end condition”) is satisfied (step S504). The second generative NN learning processing is specifically the processing illustrated in FIG. 7. The second generative NN learning end condition is, for example, the condition that the second generative NN learning processing is executed to the predetermined number of pieces of the input data.

Next, whether or not the generative NN end condition is satisfied is determined (step S505). In the case where the generative NN end condition is satisfied (step S505: YES), the processing of generating the generative NN learned model is ended. When the generation of the generative NN learned model is ended, the operation mode is changed to the input data generation mode (step S506). Next, the input data according to the random number value generated by the random number generation unit 103 is generated by the generative NN learned model (step S507). In addition, in step S507, the correct answer data generation unit 105 generates the correct answer data corresponding to the input data. In such a manner, in step S507, the learning data is generated. On the other hand, in the case where the generative NN end condition is not satisfied (step S505: NO), the flow of the processing returns to the processing in step S501.

Note that the processing in step S501, step S502, step S503 and step S504 may not be always in an order described in FIG. 8 as long as it is executed before the processing in step S505. For example, the processing may be executed in the order of step S502, step S501, step S503 and step S504.

Note that the processing in step S501 to the processing in step S505 are the processing of generating the generative NN learned model. The processing of generating the generative NN learned model does not need to be executed every time of generating one piece of the learning data. After the generative NN learned model is generated by the processing in step S501 to the processing in step S505, the plurality of pieces of the learning data may be generated by repeating the processing in step S507 without executing the processing in step S501 to the processing in step S505.

In the learning data generation device 1 configured in this way, the neural network of the discrimination unit 108 is made to learn by the discriminative NN learning processing. As a result, accuracy of determination of the discrimination unit 108 which determines whether or not the data is generated by the composition unit 104 improves. In the learning data generation device 1, the neural network of the composition unit 104 is made to learn by the first generative NN learning processing. As a result, in the composition unit 104, the accuracy of generating the image which is not easily determined as the composite image by the discrimination unit 108 improves. Such a process of learning of the composition unit 104 and the discrimination unit 108 by the discriminative NN learning processing and the first generative NN learning processing is the GAN. By such a GAN, the composition unit 104 can generate the image the difference of which from the non-composite image is smaller than the predetermined difference.

That is, the composition unit 104 can generate the image estimated as a desired label though there is a large error. The label in the learning data generation device 1 means the classification destination.

In addition, in the learning data generation device 1 configured in this way, the neural network of the classification unit 106 is made to learn by the learning target DNN learning processing. As a result, the accuracy of the classification of the classification unit 106 which classifies the data generated by the composition unit 104 according to the content indicated by the data improves. Improvement of classification accuracy means increase of the probability that the data is classified into the classification destination the difference of which from the content indicated by the generated data is smaller than the predetermined difference.

In the learning data generation device 1, the neural network of the composition unit 104 is made to learn by the second generative NN learning processing. As a result, in the composition unit 104, the accuracy of generating the data which is not easily appropriately classified by the classification unit 106 improves. In this way, in the learning data generation device 1, by the learning target DNN learning processing and the second generative NN learning processing, the accuracy that the composition unit 104 generates the data for which appropriate classification by the classification unit 106 is difficult improves.

In the learning data generation device 1, by the learning target DNN learning processing and the second generative NN learning processing, as the accuracy that the composition unit 104 generates the data for which the appropriate classification by the classification unit 106 is difficult improves, the accuracy that the classification unit 106 appropriately classifies the data improves. The data for which the appropriate classification by the classification unit 106 is difficult is, for example, the data near a boundary between the classification destinations. Therefore, in the learning data generation device 1, by the learning target DNN learning processing and the second generative NN learning processing, the composition unit 104 can generate the data near the boundary between the classification destinations. That is, the data generated by the data generation unit 112 is the data which has at least either one of a feature close to the data to which a label different from an estimation result label is imparted or a feature different from known data to which the estimation result label is imparted. The estimation result label in the learning data generation device 1 is the label estimated by the classification unit 106.

In addition, the data for which the appropriate classification by the classification unit 106 is difficult is, for example, the data which is positioned in an area of a low density in a class. The class in the learning data generation device 1 is a set of the data determined as the identical classification destination by the classification unit 106, in a feature amount space which is a virtual space where the data is mapped at a position according to the classification result of the classification unit 106. Therefore, in the learning data generation device 1, by the learning target DNN learning processing and the second generative NN learning processing, the composition unit 104 can generate the data classified into the area of the low density in the class. Note that, in the case of an expression with a word “class”, the data near the boundary between the classification destinations is the data positioned at the boundary between the classes.

In this way, in the learning data generation device 1, since the data near the boundary of the classification destination and the adjacent classification destination is generated, bias of the learning data can be reduced. Accordingly, the learning data generation device 1 configured in this way can generate the learning data which suppresses decline of the estimation accuracy by the learned neural network.

In addition, as described above, the data generated by the composition unit 104 is the data the difference of which from non-artificially generated data is smaller than the predetermined difference. Accordingly, the learning data generation device 1 configured in this way can generate the learning data which is the prepared data with less difference from the non-artificially generated data such as a picture, even though the data is near a boundary between the classification destinations.

(Modification)

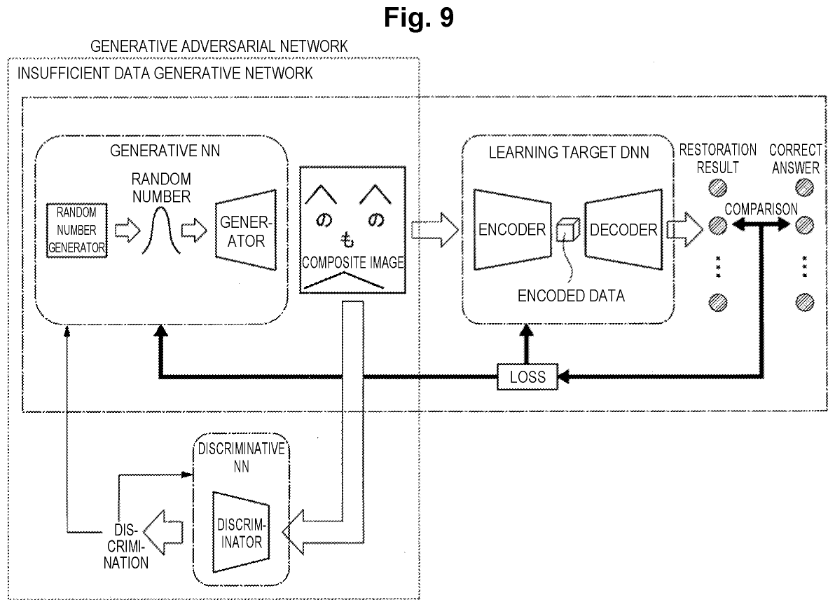

FIG. 9 is an explanatory diagram explaining the outline of a learning data generation device 1a of the modification. As described above, the learning target DNN to be made to learn by the learning data generation device 1 may be an autoencoder. Hereinafter, the learning data generation device 1 for which the learning target DNN is an autoencoder will be described as the learning data generation device 1a of the modification. In the case like this, the correct answer data is not included in the learning data.

The learning data generation device 1a is different from the learning data generation device 1 at a point that the learning target DNN is an autoencoder including an encoder and a decoder instead of a classifier. Hereinafter, in order to simplify the description, similarly to the description of the learning data generation device 1 of the embodiment, the learning data generation device 1a will be described with the case where the input data is an image as an example. Hereinafter, in order to simplify the description, the learning data generation device 1a will be described with the case where the plurality of generation methods of the input data are two generation methods of the artificial generation method and the non-artificial generation method as an example.

The autoencoder encodes and then restores the inputted input data. Hereinafter, a result of restoration by the autoencoder is referred to as a restoration result. For example, in the case where the input data is an image, the autoencoder encodes the inputted image by an encoder, and restores the encoded image by a decoder. In this case, the restoration result is a restored image.

The correct answer data in the learning data generation device 1a is different from the correct answer data in the learning data generation device 1 and is not the content of the input data but is the data itself before being encoded, which is inputted to the autoencoder.

In the learning data generation device 1a, the generative NN learns so as to increase the difference (hereinafter referred to as “restoration error”) between the restoration result and the correct answer data, based on the restoration result. More specifically, the generative NN learns so as to increase the loss function indicating the size of the restoration error. The restoration error is, for example, a least square error calculated in the autoencoder.

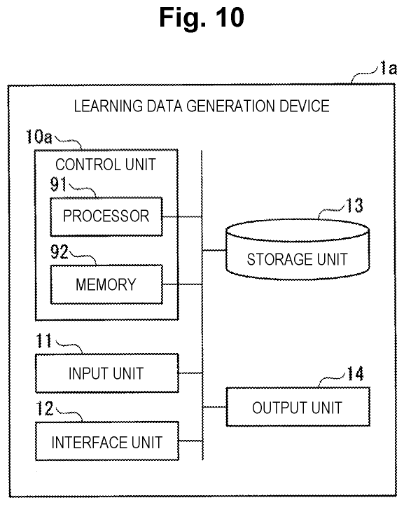

FIG. 10 is a diagram illustrating an example of the hardware configuration of the learning data generation device 1a of the modification. The learning data generation device 1a is different from the learning data generation device 1 at the point of including a control unit 10a instead of the control unit 10. Hereinafter, for components having functions similar to that of the learning data generation device 1, the description is omitted by attaching same signs as that in FIG. 2. The control unit 10a controls the operations of the various kinds of functional units provided in the learning data generation device 1a. Note that the storage unit 13 of the learning data generation device 1a stores the restoration result and the restoration error.

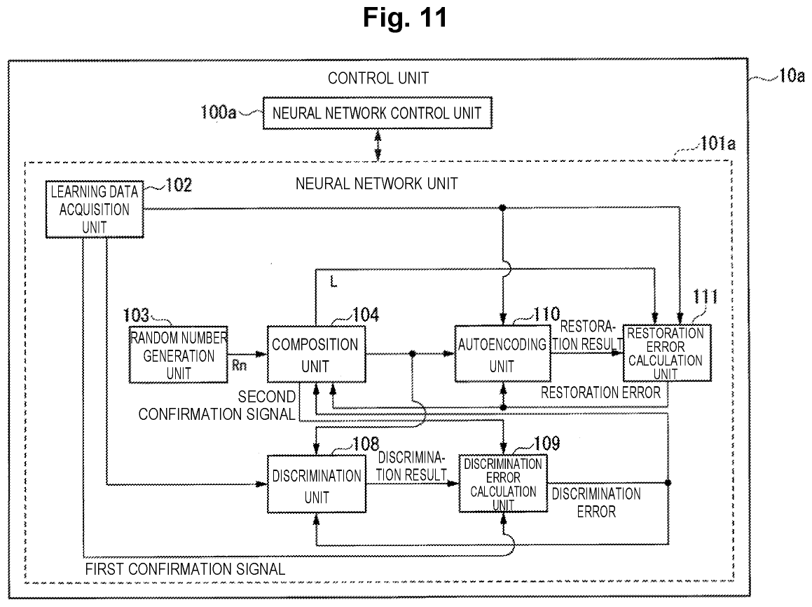

FIG. 11 is a diagram illustrating an example of the functional configuration of the control unit 10a of the modification.

The control unit 10a is different from the control unit 10 at the point of including a neural network control unit 100a instead of the neural network control unit 100 and the point of including a neural network unit 101a instead of the neural network unit 101. The neural network unit 101a is different from the control unit 10 at the point of including an autoencoding unit 110 instead of the classification unit 106 and the point of including a restoration error calculation unit 111 instead of the classification error calculation unit 107. Hereinafter, for the components having the functions similar to that of the control unit 10, the description is omitted by attaching the same signs as that in FIG. 3. The autoencoding unit 110 is a part of the learning target DNN.

The neural network control unit 100a determines the operation mode of the learning data generation device 1a. The operation mode of the learning data generation device 1a includes, specifically, the first generative NN learning mode, a third generative NN learning mode, the discriminative NN learning mode, the learning target DNN learning mode and the input data generation mode. The third generative NN learning mode is the operation mode in which the generative NN learns based on the restoration result.

The autoencoding unit 110 acquires the input data outputted by the composition unit 104. The autoencoding unit 110 encodes the inputted input data, and then restores the encoded data. Hereinafter, the processing of encoding the input data and then restoring the encoded data is referred to as autoencoding processing.

The restoration error calculation unit 111 calculates the restoration error which is the value indicating the difference between the restoration result and the correct answer data L, based on the restoration result by the autoencoding unit 110 and the correct answer data L. The restoration error is outputted to the composition unit 104 and the autoencoding unit 110. The correct answer data L in the learning data generation device 1a is the input data before being encoded by the autoencoding unit 110. For example, in the case where the input data is the data generated by the composition unit 104, the correct answer data L in the learning data generation device 1a is the input data itself generated by the composition unit 104.

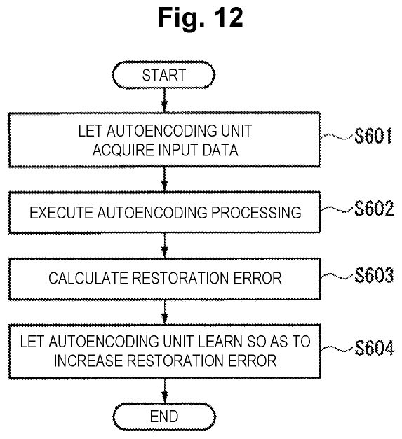

FIG. 12 is a flowchart illustrating an example of the flow of the processing executed by the learning data generation device 1a in the learning target DNN learning mode of the modification.

The autoencoding unit 110 acquires the input data (step S601). Then, the autoencoding unit 110 executes the autoencoding processing (step S602). The autoencoding unit 110 acquires the restoration result by the execution of the autoencoding processing. After the processing in step S602, the restoration error calculation unit 111 calculates the restoration error, based on the restoration result in step S602 and the correct answer data (step S603). Then, the autoencoding unit 110 learns so as to reduce the restoration error, based on the restoration error (step S604).

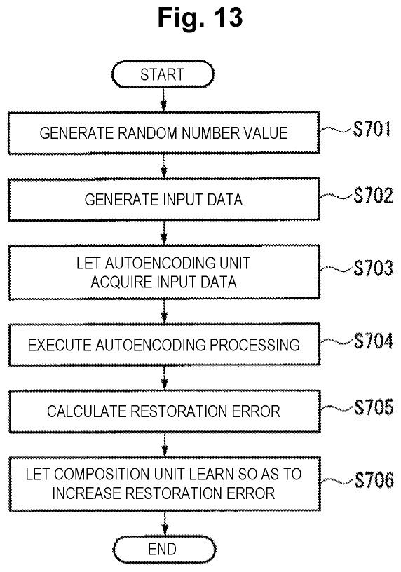

FIG. 13 is a flowchart illustrating an example of the flow of the processing executed by the learning data generation device 1a in the third generative NN learning mode of the modification.

The random number generation unit 103 generates the random number value (step S701). Then, the composition unit 104 generates the input data according to the generated random number value (step S702). Next, the autoencoding unit 110 acquires the input data (step S703).

Then, the autoencoding unit 110 executes the autoencoding processing to the input data (step S704). Next, the restoration error calculation unit 111 calculates the restoration error, based on the restoration result in step S705 and the correct answer data (that is, the input data generated in step S702) (step S705). Then, the composition unit 104 learns so as to increase the restoration error, based on the restoration error (step S706).

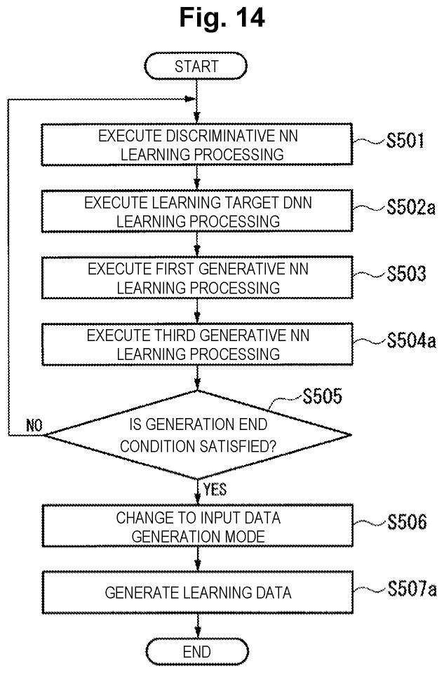

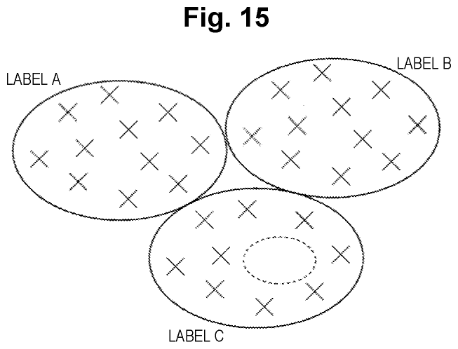

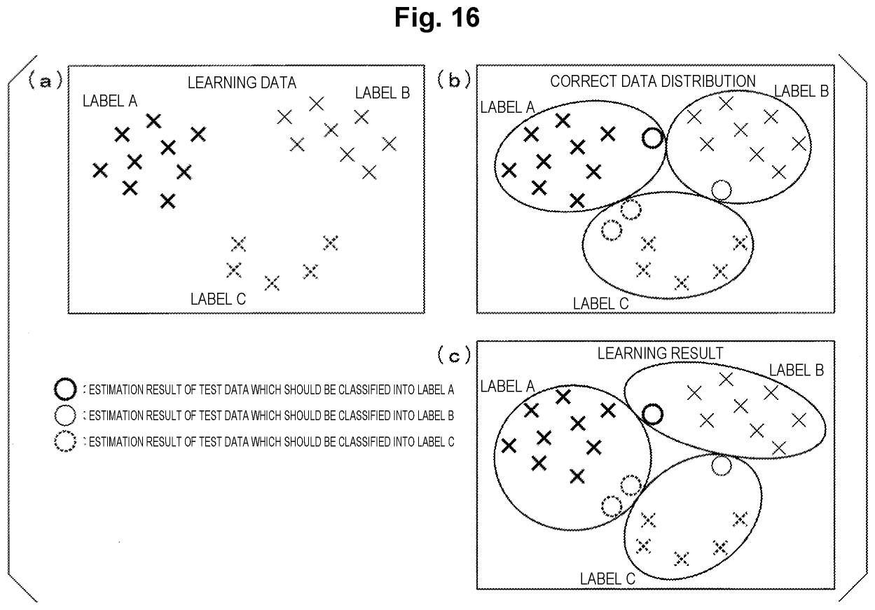

FIG. 14 is a flowchart illustrating an example of the flow of the processing that the learning data generation device 1a of the embodiment generates the learning data. More specifically, FIG. 14 is a flowchart illustrating an example of the flow of the processing that the learning data generation device 1a generates the generative NN learned model and then generates the learning data by the generative NN learned model. The processing in step S501-step S506 below is executed by the neural network control unit 100a, for example. Hereinafter, for the processing similar to the processing executed by the learning data generation device 1, the description is omitted by attaching the signs similar to that in FIG. 8.

After step S501, the learning target DNN learning processing is repeatedly executed until the learning target DNN end condition is satisfied (step S502a). The learning target DNN learning processing executed by the learning data generation device 1a is specifically the processing illustrated in FIG. 12. After step S502a, the processing in step S503 is executed.

After the processing in step S503, the processing (hereinafter referred to as “third generative NN learning processing”) in the third generative NN learning mode is repeatedly executed until a predetermined end condition (hereinafter referred to as “third generative NN learning end condition”) is satisfied (step S504a). The third generative NN learning processing is specifically the processing illustrated in FIG. 13. The third generative NN learning end condition is, for example, the condition that the third generative NN learning processing is executed to the predetermined number of pieces of the input data. After the processing in step S504a, the processing in step S505 is executed.

After the processing in step S506, the input data according to the random number value generated by the random number generation unit 103 is generated by the generative NN learned model (step S507a). In this way, in step S507a, the learning data is generated.

Note that the processing in step S501, step S502a, step S503 and step S504a may not be always in the order described in FIG. 14 as long as it is executed before the processing in step S505. For example, the processing may be executed in the order of step S502a, step S501, step S503 and step S504a.

Note that the processing in step S501 to the processing in step S505 are the processing of generating the generative NN learned model. The processing of generating the generative NN learned model does not need to be executed every time of generating one piece of the learning data. After the generative NN learned model is generated by the processing in step S501 to the processing in step S505, the plurality of pieces of the learning data may be generated by repeating the processing in step S507a without executing the processing in step S501 to the processing in step S505.

In the learning data generation device 1a configured in this way, the neural network of the autoencoding unit 110 is made to learn by the learning target DNN learning processing. As a result, the accuracy of the restoration of the autoencoding unit 110 which encodes and then restores the data generated by the composition unit 104 improves. The improvement of the restoration accuracy means the restoration of the data the difference of which from the data before being encoded is smaller than the predetermined difference.

In the learning data generation device 1a, the neural network of the composition unit 104 is made to learn by the third generative NN learning processing. As a result, in the composition unit 104, the accuracy of generating the data which is not easily restored by the autoencoding unit 110 improves. In this way, in the learning data generation device 1a, by the learning target DNN learning processing and the third generative NN learning processing, the accuracy that the composition unit 104 generates the data for which the restoration by the autoencoding unit 110 is difficult improves.

In the learning data generation device 1, by the learning target DNN learning processing and the third generative NN learning processing, as the accuracy that the composition unit 104 generates the data for which the restoration by the autoencoding unit 110 is difficult improves, the accuracy that the autoencoding unit 110 restores the data improves. The data for which the restoration by the autoencoding unit 110 is difficult is, for example, the data greatly different from the data that has been already restored before. Therefore, in the learning data generation device 1a, by the learning target DNN learning processing and the third generative NN learning processing, the composition unit 104 can generate the data greatly different from the data that has been already restored before. That is, the data generated by the composition unit 104 is the data which has at least either one of the feature close to the data to which a label different from the estimation result label is imparted or the feature different from the known data to which the estimation result label is imparted. The estimation result label in the learning data generation device 1a is the label estimated by the autoencoding unit 110. The label in the learning data generation device 1a means the image of the restoration result or the image before being encoded.

In addition, the data for which the restoration by the autoencoding unit 110 is difficult is, for example, the data which is positioned in the area of the low density in the class. The class in the learning data generation device 1a is a set of the data for which the difference between the data restored by the autoencoding unit 110 is within the predetermined difference in a feature amount space. The feature amount space in the learning data generation device 1a is the virtual space where the data is mapped at a position according to the restoration result of the autoencoding unit 110. Therefore, in the learning data generation device 1a, by the learning target DNN learning processing and the third generative NN learning processing, the composition unit 104 can generate the data restored in the area of the low density in the class.

In this way, in the learning data generation device 1a, since the data greatly different from the data that has been already restored before is generated, the bias of the learning data can be reduced. Accordingly, the learning data generation device 1a configured in this way can generate the learning data which suppresses the decline of the estimation accuracy by the learned neural network.

In addition, as described above, the data generated by the composition unit 104 is the data the difference of which from the non-artificially generated data is smaller than the predetermined difference. Accordingly, the learning data generation device 1a configured in this way can generate the learning data which is the prepared data with less difference from the non-artificially generated data such as a picture even while it is the data greatly different from the data that has been already restored before.

Examples of a learning data generation method are the processing in step S501-step S507 illustrated in FIG. 8, and the processing in step S501-step S507a illustrated in FIG. 14.

Note that the classification error does not always require a plurality of results outputted by the classification unit 106, differently from the discrimination error. The restoration error does not always require a plurality of results outputted by the autoencoding unit 110, differently from the discrimination error.

Note that the learning target DNN may be a neural network which executes noise elimination. The learning target DNN may be a neural network which detects objects. The learning target DNN may be a neural network which executes colorization of monochrome images. The learning target DNN may be a neural network which executes segmentation. The learning target DNN may be a neural network which estimates motions between images. The learning target DNN may be a neural network of style transfer. The learning target DNN may be a neural network which makes images three-dimensional. The learning target DNN is not necessarily a neural network which processes images, and may be a neural network which processes languages or may be a neural network which processes sound.

The learning target DNN is an example of a predetermined estimation model. The learning target DNN is an example of an estimation model which is an object to be made to learn. In the discriminative NN learning processing, the learning target DNN learning processing, the first generative NN learning processing, the second generative NN learning processing and the third generative NN learning processing, the processing in which the input data is generated and the processing in which the correct answer data is generated are examples of a generation step.

The learning data generation device 1 and the learning data generation device 1a are examples of a data generation device. The correct answer data is an example of a predetermined label. The learning data generation method is an example of a data generation method. The data generation unit 112 and the composition unit 104 provided in the control unit 10a are examples of a generation unit.

The processing that the discrimination unit 108 discriminates the input data is an example of a discrimination step. The processing that the composition unit 104 learns based on the discrimination error is an example of a first generative learning step. The processing that the discrimination unit 108 learns based on the discrimination error is an example of a discriminative learning step. Note that the discrimination error is an example of a first error. The non-composite image is an example of the prepared learning data.

The classification error and the restoration error are examples of a second error. The processing that the classification error calculation unit 107 calculates the classification error and the processing that the restoration error calculation unit 111 calculates the restoration error are examples of a second error acquisition step. The processing that the composition unit 104 learns based on the classification error is an example of a second generative learning step. The processing that the composition unit 104 learns based on the restoration error is an example of the second generative learning step.

Note that the learning data generation device 1 and the learning data generation device 1a may be mounted using a plurality of information processors connected communicably via a network. In this case, the individual functional units provided in the learning data generation device 1 and the learning data generation device 1a may be distributed and mounted in the plurality of information processors. For example, the discrimination unit 108 and the discrimination error calculation unit 109 may be mounted on the information processor different from the other functional units provided in the control unit 10 and the control unit 10a.

All or a part of the individual functions of the learning data generation device 1 and the learning data generation device 1a may be achieved using hardware such as an ASIC (Application Specific Integrated Circuit), a PLD (Programmable Logic Device) or an FPGA (Field Programmable Gate Array). The program may be recorded in a computer-readable recording medium. The computer-readable recording medium is a storage device such as a portable medium like a flexible disk, a magneto-optical disk, a ROM or a CD-ROM, or a hard disk built in a computer system. The program may be transmitted via a telecommunication line.

While the embodiment of the present invention has been described in detail with reference to the drawings above, the specific configuration is not limited to the embodiment, and designs or the like in a range not deviating from the spirit of the present invention are also included.

### Reference Signs List

1, 1a Learning data generation device

10, 10a Control unit

11 Input unit

12 Interface unit

13 Storage unit

14 Output unit

100, 100a Neural network control unit

101, 101a Neural network unit

102 Learning data acquisition unit

103 Random number generation unit

104 Composition unit

105 Correct answer data generation unit

106 Classification unit

107 Classification error calculation unit

108 Discrimination unit

109 Discrimination error calculation unit

110 Autoencoding unit

111 Restoration error calculation unit

112 Data generation unit

1. A data generation method which generates data based on a predetermined estimation model, the method comprising
a generation step of generating data estimated as a predetermined label by the estimation model and provided with the predetermined label,
wherein generated data has at least either one of
a feature close to data to which a label different from the predetermined label is imparted or
a feature different from known data to which the predetermined label is imparted.

2. The data generation method according to claim 1,
wherein data which increases a difference between an estimation result of the estimation model and the generated data is generated in the generation step.

3. The data generation method according to claim 1,
wherein a virtual space where data is mapped at a position according to an estimation result by the estimation model, the known data being mapped in the virtual space, is a feature amount space, a set of the data for which the label estimated by the estimation model is identical is a class in the feature amount space, and the data generated in the generation step is mapped at a boundary between the class and another class or in an area of a low density in the class when mapped in the feature amount space.

4. The data generation method according to claim 2,
wherein the generated data is generated using a generative neural network which is a neural network in the generation step, and the generated data is input data of learning data inputted to the estimation model which is an object to be made to learn, the method comprising:
a discrimination step of determining which method of predetermined methods a generation method of the generated data is, by a discriminative neural network which is a neural network that determines which method of predetermined methods the generation method of the generated data is; and
a first generative learning step in which the generative neural network learns so as to increase a probability that a result of discrimination in the discrimination step is erroneous, based on a first error which is a value indicating a probability that the result of the discrimination in the discrimination step is correct,
wherein the generation step includes a second error acquisition step of acquiring a second error which indicates a difference between a result of processing by the estimation model to the generated data and the generated data, and a second generative learning step in which the generative neural network learns so as to increase the difference indicated by the second error based on the second error, and
the estimation model learns so as to determine that the learning data including the input data generated in the generation step is not prepared learning data, using the learning data including the input data generated in the generation step and the learning data which is the prepared learning data and includes input data not generated in the generation step.

5. The data generation method according to claim 4,
wherein the discriminative neural network learns so as to increase the probability that the result of the discrimination is correct, based on the first error.

6. A data generation device which generates data based on a predetermined estimation model, the device comprising
a processor; and
a storage medium having computer program instructions stored thereon, when executed by the processor, perform to:
generate data estimated as a predetermined label by the estimation model and provided with the predetermined label,
wherein generated data has at least either one of
a feature close to data to which a label different from the predetermined label is imparted or
a feature different from known data to which the predetermined label is imparted.

7. A non-transitory computer-readable medium having computer-executable instructions that, upon execution of the instructions by a processor of a computer, cause the computer to function as the data generation device according to claim 6.
